(19) United States
(12) Patent Application Publication
(10) Pub. No.: US 2024/0428640 A1
(43) Pub. Date: Dec. 26, 2024

(54) BANKNOTE COUNTER HAVING WHITE-LIGHT-REFLECTED SENSOR RECOGNIZING MONOCHROME IMAGES

(71) Applicant: Anhui Chenguang Electronic Technology Co., Ltd., Huangshan (CN)

(72) Inventor: Yueli ZHOU, Huangshan (CN)

(21) Appl. No.: 18/409,733

(22) Filed: Jan. 10, 2024

(30) Foreign Application Priority Data
Jun. 26, 2023 (CN) 202321652870.8

(51) Int. Cl. G07D 11/50; G06V 30/42; G07D 7/202; H04N 23/56; H04N 25/701

(52) U.S. Cl. CPC G07D 11/50; G06V 30/42; G07D 7/202; H04N 23/56; H04N 25/701; G07D 2207/00

(57) ABSTRACT

The present invention relates to a banknote counter having a white-light-reflected sensor recognizing monochrome images including at least one white-light-reflected sensor recognizing monochrome images. The at least one white-light-reflected sensor recognizing monochrome images includes at least one row of sensor units, each sensor unit is provided with a white-light-receiving assembly, a white-light-emitting assembly and a light-transmitting white glass piece. The white-light-emitting assembly includes an emission circuit board and two spaced white-light-emitting tubes disposed on the emission circuit board, wherein a light-transmitting hole is set between the two spaced white light-emitting tubes. The white-light-receiving assembly includes a receiving circuit board and a white-light-receiving tube disposed on the receiving circuit board, wherein the white-light receiving-tube faces the light transmitting hole on the white-light-emitting assembly.

### FIELD OF THE INVENTION

The present invention relates to the technical field of banknote counters and banknote-grouping machines, and in particular relates to a white-light-reflection imaging banknote counter.

### BACKGROUND OF THE INVENTION

A banknote counter/detector is a mechanical-electrical integrated machine capable of counting banknotes, distinguishing fake banknotes, and identifying denominations. A banknote-grouping machine is a mechanical-electrical integrated machine capable of sorting orientations of banknotes, counting banknotes, distinguishing fake banknotes, and identifying denominations. At present, there are image-recognizing sensors installed inside the machines of the banknote counter/detector in China, mainly using high-resolution CMOS image sensors and low-resolution infrared imaging sensors. The high-resolution CMOS image sensors are more costed, generally used in high-end market environments such as bank counters and treasuries; the low-resolution infrared imaging sensors is less costed, but has disadvantages such as fewer infrared points, low imaging pixels, and insufficient image clarity. In some countries, banknotes do not contain infrared ink, so infrared imaging sensors cannot distinguish fake banknotes from genuine banknotes; or if the infrared image is close, the infrared imaging sensor will mistakenly identify denominations.

In view of the above problems, it is necessary to design a better banknote counter to solve the problems in the art.

### SUMMARY OF THE INVENTION

The technical problem to be solved by the present invention is to provide a banknote counter having a white-light-reflected sensor recognizing monochrome images, so as to achieve monochrome imaging and distinguish the false from the genuine.

In order to achieve the above objective, the present invention adopts the following technical solution. A banknote counter having a white-light-reflected sensor recognizing monochrome images includes at least one white-light-reflected sensor recognizing monochrome images, the at least one white-light-reflected sensor recognizing monochrome images includes at least one row of sensor units, each sensor unit is provided with a white-light-receiving assembly, a white-light-emitting assembly and a light-transmitting white glass piece, the white-light-emitting assembly includes an emission circuit board and two spaced white light-emitting tubes disposed on the emission circuit board, wherein a light-transmitting hole is set between the two spaced white light-emitting tubes; the white-light-receiving assembly includes a receiving circuit board and a white-light-receiving tube disposed on the receiving circuit board, the white-light receiving-tube faces the light transmitting hole on the white-light-emitting assembly. The white-light-emitting assemble emits a white light beam to a paper banknote to execute scanning recognition under white light, thereby forming a refracted beam, and the refracted beam passes through the light-transmitting hole to be irradiated onto the white-light-receiving tube and performs an imaging process through a processor to form a clear monochrome image, so as to clearly identify and recognize the paper banknote.

Preferably, a center distance between said two spaced white-light-emitting tubes on said white-light-emitting assembly is 2-5 mm.

Preferably, a center distance between said white-light-emitting tubes on each sensor unit is 2-5 mm.

Preferably, a center distance between said white-light-receiving tubes on each sensor unit is 0.5-1.5 mm.

Preferably, said white-light-receiving tubes on said sensor unit on said at least one white-light-reflected sensor recognizing monochrome images are 120-260 in number.

Preferably, said at least one white-light-reflected sensor recognizing monochrome images comprises an upper white-light-reflected sensor recognizing monochrome images and a lower upper white-light-reflected sensor recognizing monochrome images, which are arranged opposite to and misaligned with each other, said upper white-light-reflected sensor recognizing monochrome images and said lower upper white-light-reflected sensor recognizing monochrome images are same with each other in structure, a banknote passage is formed between said upper white-light-reflected sensor recognizing monochrome images and said lower upper white-light-reflected sensor recognizing monochrome images.

Compared with the prior art, the effective effects of the present invention are as follows. The present invention discloses a banknote counter having a white-light-reflected sensor recognizing monochrome images. The emission assembly emits a white light beam to one side of a paper banknote, and performing scanning and recognition with white light on the paper banknote passing through a banknote passage, thereby forming refraction, from which a refracted white light beam passes through each corresponding small hole (the diameter of the aperture is 0.5-1.2 mm) on a white-light plate, then beams the white-light-receiving sensor. The sensor of the receiving assemble executes an imaging process through CPU to form a clear monochrome image, by which a clear identification of the Arabic numeral denomination can performed on the banknote. Since two groups of the white-light-reflected sensors recognizing monochrome images are provided opposite each other, the device can form two front and back monochrome images, and then identifies the denomination of the banknote and distinguishes fake banknotes from genuine banknotes through comparison between databases. The white-light-reflected sensor recognizing monochrome images designed as the present solution can identify banknotes and financial bonds from any country in the world.

### BRIEF DESCRIPTION OF THE DRAWINGS

FIG. 1 is a perspective diagram of the banknote counter having a white-light-reflected sensor recognizing monochrome images according to the present invention.

FIG. 2 is an internal structure diagram of the banknote counter having a white-light-reflected sensor recognizing monochrome images according to the present invention.

FIG. 3 is an entire structure diagram of the white-light-reflected sensor recognizing monochrome images according to the present invention.

FIG. 4 is an enlarged longitudinal cross-sectional view of the white-light-reflected sensor recognizing monochrome images according to the present invention.

FIG. 5 is an exploded diagram of the white-light-reflected sensor recognizing monochrome images according to the present invention.

FIG. 6 is a partial assembly diagram of the white-light-reflected sensor recognizing monochrome images according to the present invention.

FIG. 7 is a side view of the white-light-reflected sensor recognizing monochrome images according to the present invention.

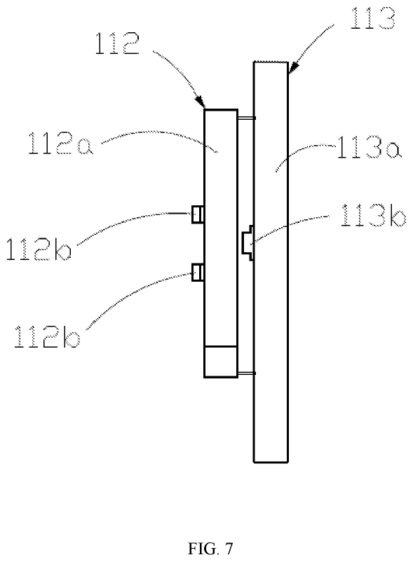

### DETAILED DESCRIPTION OF THE PREFERRED EMBODIMENTS

In order to make the technical solution, creative characteristics, achieved objective and effect of the present invention easy to understand, we shall further describe the present invention in combination with the following specific embodiments.

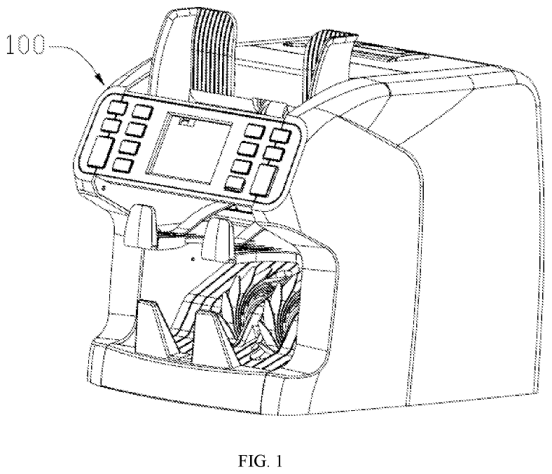

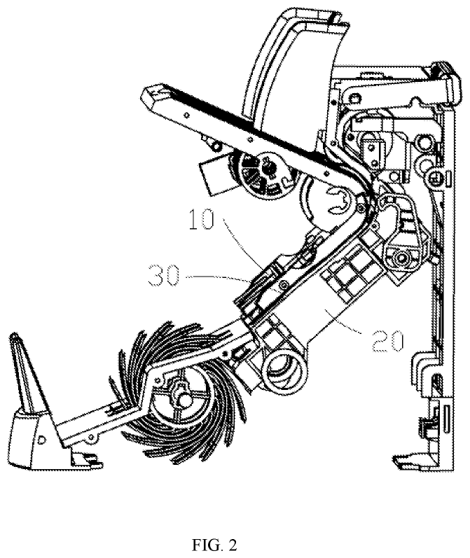

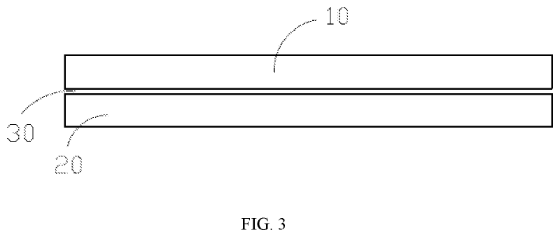

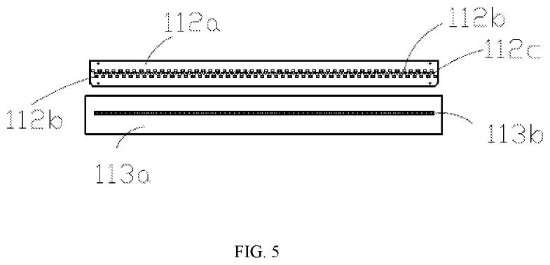

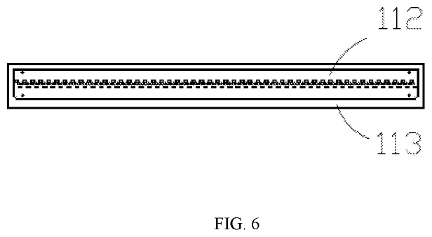

As shown in FIGS. 1-6, the present invention provides a banknote counter 100 having a white-light-reflected sensor recognizing monochrome images, the function and some parts of the banknote counter and those of the existing banknote counter are similar to each other, for example, both have a banknote-grouping assembly, a display assembly, a banknote-feeding table, a motor, a banknote-receiving assembly, a transmission assembly, a banknote-blocking piece, a circuit board with a processor, and so on. Among them, the banknote-grouping assembly includes a banknote-grouping wheel and a banknote-pressing wheel.

The banknote counter 100 having a white-light-reflected sensor recognizing monochrome images provided by the present invention is different from the existing banknote counter in that it has the white-light-reflected sensor recognizing monochrome images that is different from other kinds of sensors. The white-light-reflected sensor recognizing monochrome images includes an upper white-light-reflected sensor recognizing monochrome images 10 and a lower upper white-light-reflected sensor recognizing monochrome images 20, which are arranged opposite to and misaligned with each other, the upper white-light-reflected sensor recognizing monochrome images 10 and the lower upper white-light-reflected sensor recognizing monochrome images 20 are same with each other in structure. Furthermore, a 1.5-2.5 mm spaced banknote passage 30 is formed between the upper white-light-reflected sensor recognizing monochrome images 10 and the lower upper white-light-reflected sensor recognizing monochrome images 20.

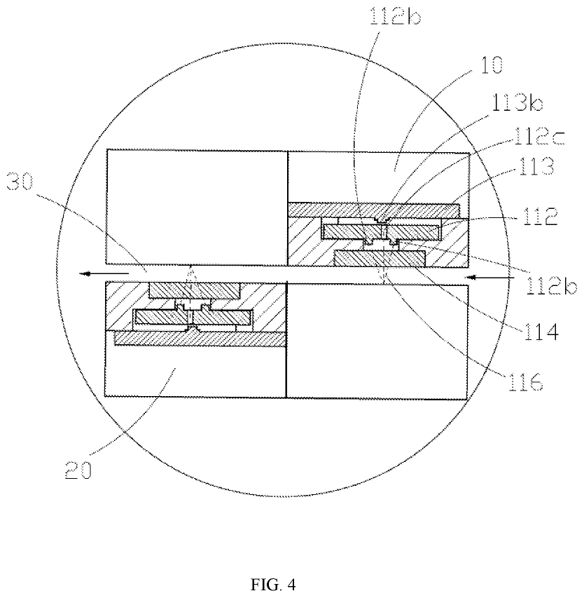

Referring to FIG. 4, the upper white-light-reflected sensor recognizing monochrome images 10 includes at least one row of sensor units 11, in this embodiment, the upper white-light-reflected sensor recognizing monochrome images 10 includes two rows of numerous sensor units 11.

Each sensor unit 11 is provided with the white-light-receiving assembly 113, the white-light-emitting assembly 112 and the light-transmitting white glass piece 114 from top to bottom. The white-light-emitting assembly 112 is arranged in the same direction as white-light-receiving assembly 113. The light-transmitting white glass piece 114 is bonded and fixed with a special glue to prevent dust from entering it.

The white-light-emitting assembly 112 includes the emission circuit board 112a and two spaced white light-emitting tubes 112b disposed on the emission circuit board 112a. The light-transmitting hole 112c is arranged between the two spaced white light-emitting tubes 112b. The center distance between the white-light-emitting tubes 112b on the white-light-emitting assembly 112 is 2-5 mm. The center distance between the two rows of parallel sensor units 11 is 2-5 mm. The sensor unit 11 may also be arranged in a single row, the center distance between the white-light-emitting tubes 112b is set to 2-5 mm.

The white-light-receiving assembly 113 includes the receiving circuit board 113a and the white-light-receiving tube 113b disposed on the receiving circuit board 113a. The white-light receiving-tube 113b faces the light transmitting hole 112c on the white-light-emitting assembly 112. The interval between the white-light receiving-tubes 113b on each sensor unit is 0.5-1.5 mm, and the wavelength of white light is 400-1100 nanometers. The number of the white-light-receiving tubes 113b may be 120-260.

The interval of all white-light-receiving tubes 113b on the white-light-receiving assembly 113 is 0.8 mm, in this embodiment, the white-light-receiving tubes 113b on the white-light-receiving assembly 113 are 175 in number, encapsulated in a strip on the receiving circuit board 113a.

The two spaced white-light-emitting tubes 112b on the white-light-emitting assembly 112 emits light, which is reflected through the optical path 116, then passes through the light-transmitting hole 112c, finally is received by the white-light-receiving tube 113b. A small hole with a diameter of 0.5-1.0 mm used to separate interfering light is arranged in the interspace between the two rows of the white-light-emitting tubes, and the bottom of the small hole is provided with a white-light-receiving tube sensor. Such structure ensures that each white-light-receiving sensor will not receive interfering light from sides, so as to guarantee a clearer monochrome image synthesized from white light.

The high-density arrangement of the sensor units 11 can effectively improve the imaging pixels and make the monochrome image clearer, so as to replace the current high-cost CIS sensor and low-resolution infrared imaging sensor.

The white-light-reflected sensor recognizing images are stacked at time of emitting and receiving white light, and the paper banknote passes through the banknote passage 30 to present a monochrome image according to the white light reflection principle (as shown in the arrow direction of FIG. 4). The present invention has a novel design layout and a compact structure, based on the reasonable design layout, such as the high-density arrangement of the sensor units, the center distance of adjacent two sensor units as 0.8 mm and the straight distribution of 175 sensor units in a strip providing high imaging pixels, a processor (CPU) can give a monochrome image processed as clear as an original image, thereby achieving the purpose of identifying banknotes and financial bonds from any country in the world. The 175 receiving sensors perform recognition and scanning without blind areas, achieving replacing current CIS sensors and reducing production costs, so it is suitable for the demand of mass production for market. In the embodiment of the present invention, the banknote counter/detector is not limited to an upright counter/detector, but also includes a horizontal type counter/detector and a dynamic discriminator and a multi-port banknote-sorting machine.

The present invention provides a white-light-reflected sensor device recognizing monochrome images. The emission assembly emits a white light beam to one side of a paper banknote, and performing scanning and recognition with white light on the paper banknote passing through a banknote passage, thereby forming refraction, from which a refracted white light beam passes through each corresponding small round hole on a white-light plate, then beams the white-light-receiving sensor. The sensor of the receiving assemble executes an imaging process through CPU to form a clear monochrome image, by which a clear identification of the Arabic numeral denomination can performed on the banknote. Since two groups of the white-light-reflected sensors recognizing monochrome images are provided opposite each other, the device can form two front and back monochrome images, and then identifies the denomination of the banknote and distinguishes fake banknotes from genuine banknotes through comparison between databases. The white-light-reflected sensor recognizing monochrome images designed as the present solution can identify banknotes and financial bonds from any country in the world. The device provides high imaging pixels and clearer images, which can achieve the effect of CIS sensors, thereby reducing machine costs and improving market popularity.

The above content is only better embodiments of the present invention, not intended to impose any limitations on the present invention, and any modification, equivalent substitution, improvement and the likes made within the essence and principle of the present invention will fall within the protection scope of the present invention.

It should be noted that relation terms such as “first and second”, “number of sensors” and “center distance size” are only used to distinguish one entity or operation from another, and do not necessarily require or imply any such actual relation or order between these entities or operations. Moreover, the terms “include”, “comprise”, or any other variation thereof means non-exclusive inclusion, so that a process, method, object or device includes a series of elements includes not only those elements, but also other elements not expressly listed, or also includes elements inherent in such process, method, object or device.

Although embodiments have been shown and described in the present invention, for a person skilled in the art, it is understandable that without departing from the principle and essence of the present invention, a variety of changes, modifications, substitutions and variants may be made to these embodiments, and the scope of the present invention is defined by the claims and their equivalents.

What is claimed is:

1. A banknote counter having a white-light-reflected sensor recognizing monochrome images, comprising at least one white-light-reflected sensor recognizing monochrome images, wherein said at least one white-light-reflected sensor recognizing monochrome images comprises at least one row of sensor units, each sensor unit is provided with a white-light-receiving assembly, a white-light-emitting assembly and a light-transmitting white glass piece; said white-light-emitting assembly comprises an emission circuit board and two spaced white-light-emitting tubes disposed on said emission circuit board, wherein a light-transmitting hole is set between said two spaced white light-emitting tubes; said white-light-receiving assembly comprises a receiving circuit board and a white-light-receiving tube disposed on said receiving circuit board, wherein said white-light receiving-tube faces said light transmitting hole on said white-light-emitting assembly;
and wherein said white-light-emitting assemble emits a white light beam to a paper banknote to execute scanning recognition under white light, thereby forming a refracted beam, and the refracted beam passes through said light-transmitting hole to be irradiated onto said white-light-receiving tube and performs an imaging process through a processor to form a clear monochrome image, so as to clearly identify and recognize the paper banknote.

2. The banknote counter having a white-light-reflected sensor recognizing monochrome images according to claim 1, wherein a center distance between said two spaced white-light-emitting tubes on said white-light-emitting assembly is 2-5 mm.

3. The banknote counter having a white-light-reflected sensor recognizing monochrome images according to claim 1, wherein a center distance between said white-light-emitting tubes on each sensor unit is 2-5 mm.

4. The banknote counter having a white-light-reflected sensor recognizing monochrome images according to claim 1, wherein a center distance between said white-light-receiving tubes on each sensor unit is 0.5-1.5 mm.

5. The banknote counter having a white-light-reflected sensor recognizing monochrome images according to claim 1, wherein said white-light-receiving tubes on said sensor unit on said at least one white-light-reflected sensor recognizing monochrome images are 120-260 in number.

6. The banknote counter having a white-light-reflected sensor recognizing monochrome images according to claim 1, wherein said at least one white-light-reflected sensor recognizing monochrome images comprises an upper white-light-reflected sensor recognizing monochrome images and a lower upper white-light-reflected sensor recognizing monochrome images, which are arranged opposite to and misaligned with each other, said upper white-light-reflected sensor recognizing monochrome images and said lower upper white-light-reflected sensor recognizing monochrome images are same with each other in structure, a banknote passage is formed between said upper white-light-reflected sensor recognizing monochrome images and said lower upper white-light-reflected sensor recognizing monochrome images.
